(19) United States
(12) Patent Application Publication
(10) Pub. No.: US 2016/0135125 A1
(43) Pub. Date: May 12, 2016

(54) OPERATING A WIRELESS RECEIVER OF A WIRELESS STATION IN POWER-SAVINGS MODE

(71) Applicant: GainSpan Corporation, San Jose, CA (US)

(72) Inventors: Pankaj Vyas, Bangalore (IN); Vishal Batra, Bangalore (IN)

(21) Appl. No.: 14/537,909

(22) Filed: Nov. 11, 2014

(51) Int. Cl. H04W 52/02

(52) U.S. Cl. CPC H04W 52/0258

(57) ABSTRACT

A wireless station of a wireless network receives data indicating inactive time durations during a day. The wireless station places a receiver, used to receive data from the wireless network, in power savings mode during the inactive time durations. The wireless station receives data when operating in an active mode. Power consumption in the wireless station is reduced. In an embodiment, the receiver is implemented according to IEEE 802.11 standards.

### BACKGROUND

1. Technical Field

Embodiments of the present disclosure relate generally to wireless stations, and more specifically to operating a wireless receiver of a wireless station in power-savings mode.

2. Related Art

A wireless station refers to an end station of a wireless network. In one common scenario, wireless stations rely on access points as switching devices for transporting packets from one wireless station to another wireless station. Thus, wireless stations are the end points of (potentially multi-hop) communication based on wireless medium.

Wireless receivers are integral components of wireless stations, and are used for receiving data, for example from access points. It is generally desirable to operate wireless stations in power-savings mode, at least for reducing power consumption.

Aspects of the present disclosure are directed to operating a wireless station in power savings mode.

### BRIEF DESCRIPTION OF THE VIEWS OF DRAWINGS

Example embodiments of the present invention will be described with reference to the accompanying drawings briefly described below.

FIG. 1 is a block diagram of an example environment in which several aspects of the present disclosure may be implemented.

FIG. 2 is a flow chart illustrating the manner in which a wireless receiver of a wireless station is operated in power savings mode in an embodiment.

FIG. 3 is a diagram illustrating the entries in a schedule created in a wireless station, in an embodiment.

FIG. 4 is a timing diagram illustrating the modes of operation of a wireless station according to a schedule, in an embodiment.

FIG. 5 is a block diagram illustrating the implementation details of a wireless station in an embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

A wireless station of a wireless network receives data indicating expected inactive time durations during a day. The wireless station places a receiver in power savings mode during the inactive time durations. The wireless station receives data from wireless networks, when operating in an active mode. In an embodiment, the receiver is implemented according to IEEE 802.11 standards. Power consumption in the wireless station is reduced as a result.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

### 2. Example Environment

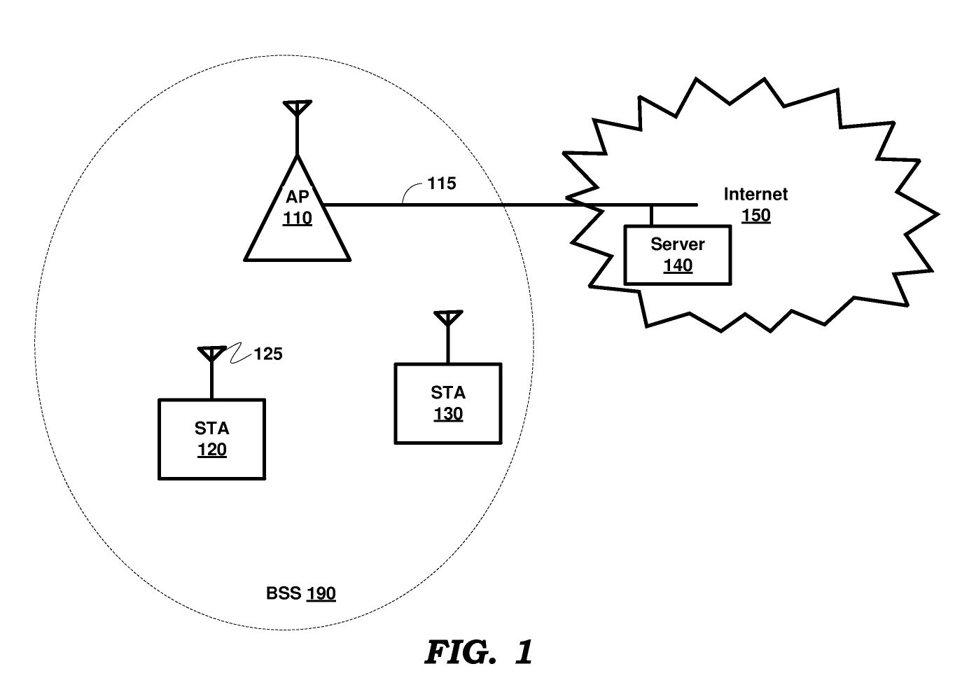

FIG. 1 is a block diagram representing an example environment in which several aspects of the present disclosure can be implemented. The example environment is shown containing only representative devices and systems for illustration. However, real world environments may contain more or fewer systems. FIG. 1 is shown containing access point (AP) 110, wireless stations (STA) 120 and 130, and internet 150. Server 140 is shown as being contained in internet 150. AP 110 and STAs 120 and 130 are generically referred to herein as wireless devices. STA 120 is shown containing antenna 125. AP 110 and STA 130 are also shown containing antennas, but not numbered.

Although, only two STAs are shown, the environment of FIG. 1 may contain more or less than two STAs also. Further, in the description below, the devices and the environment are described as operating consistent with Wireless Local Area Network (WLAN) according to IEEE 802.11 standard(s), merely for illustration Implementations in other environments are also contemplated to be within the scope and spirit of various aspects of the present invention.

Internet 150 extends the connectivity of wireless devices 120 and 130 to various systems (e.g., server 140) connected to, or part of, internet 150. Internet 150 is shown connected to access point (AP) 110 through a wired path 115. STAs 120 and 130 may access devices/systems in internet 150 (including server 140) via AP 110. Internet 150 may be implemented using protocols such as IP. In general, in IP environments, an IP packet is used as a basic unit of transport, with the source address being set to the IP address assigned to the source system from which the packet originates and the destination address set to the IP address of the destination system to which the packet is to be eventually delivered. The IP packet is encapsulated in the payload of layer-2 packets when being transported across WLANs.

An IP packet is said to be directed to a destination system when the destination IP address of the packet is set to the IP address of the destination system, such that the packet is eventually delivered to the destination system. When the packet contains content such as port numbers, which specifies the destination application, the packet may be said to be directed to such application as well. The destination system may be required to keep the corresponding port numbers available/open, and process the packets with the corresponding destination ports.

Block 190, shown containing AP 110 and STAs 120 and 130, represents a basic service set (BSS) of an infrastructure mode wireless network consistent with the IEEE 802.11 standard. Although only a single BSS is shown and described, other environments may include more than one BSS, with the BSSs being interconnected to form an extended service set (ESS) consistent with IEEE 802.11 standards, as is well known.

Each of STAs 120 and 130 represent end devices of wireless network (BSS 190), and may be the source or destination (i.e., consumer) of data packets (data units). Each STA may execute corresponding applications, such as, for example, collecting temperature/pressure information of a corresponding unit via sensors.

AP 110 represents a switching device, and forwards data packets received from one STA to the other STA. AP 110 also forwards data packets received from any of the STAs and destined for a device(s) (including server 140) in internet 150. AP 110 may receive data packets from internet 150 (including from server 140) and forward the data packets to the corresponding destination STA(s). Further, AP 110 may perform various other operations consistent with IEEE 802.11 (WLAN) standards, as is well known in the relevant arts.

Server 140 represents a device which provides expected inactive time durations for each STA, according to aspects of the present disclosure. Though shown connected by wired path in Internet 150, server 140 may be accessible by wireless paths as well.

It may be desirable to reduce power consumption in STA 120. The reduction may be attained by placing in power-savings mode, (at least a portion of) the wireless receiver based on various conditions in accordance with features of the present disclosure, as described below with examples.

### 3. Power Savings Schedule

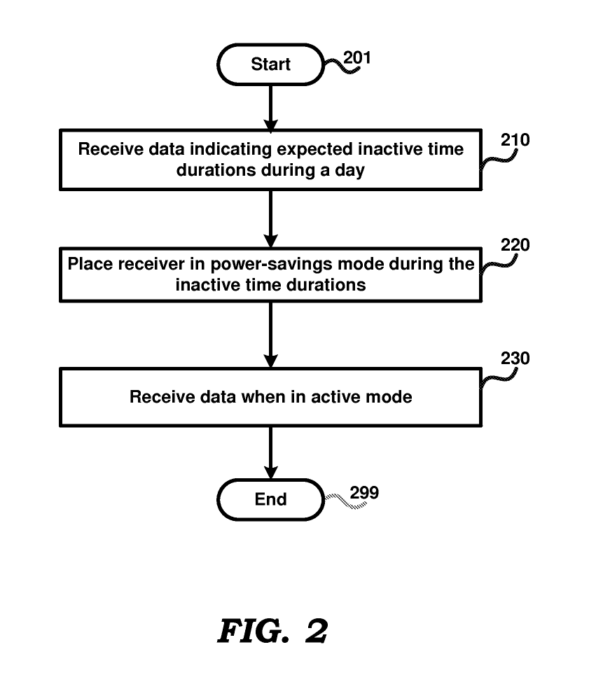

FIG. 2 is a flow chart illustrating the manner in which power consumption in a wireless station providing network connectivity for an embedded device, in an embodiment of the present disclosure. Merely for illustration, the flowchart is described below as being performed in STA 120. However, the features can be implemented in STA 130, as well as in other systems and environments without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, STA 120 receives data indicating inactive time durations during a day. The inactive time durations specify time intervals during the day that STA 120 is not expected to (or not to) receive any data packets from an external device (via AP 110). STA 120 may store information specifying the inactive time durations in an internal memory. Control then passes to step 220.

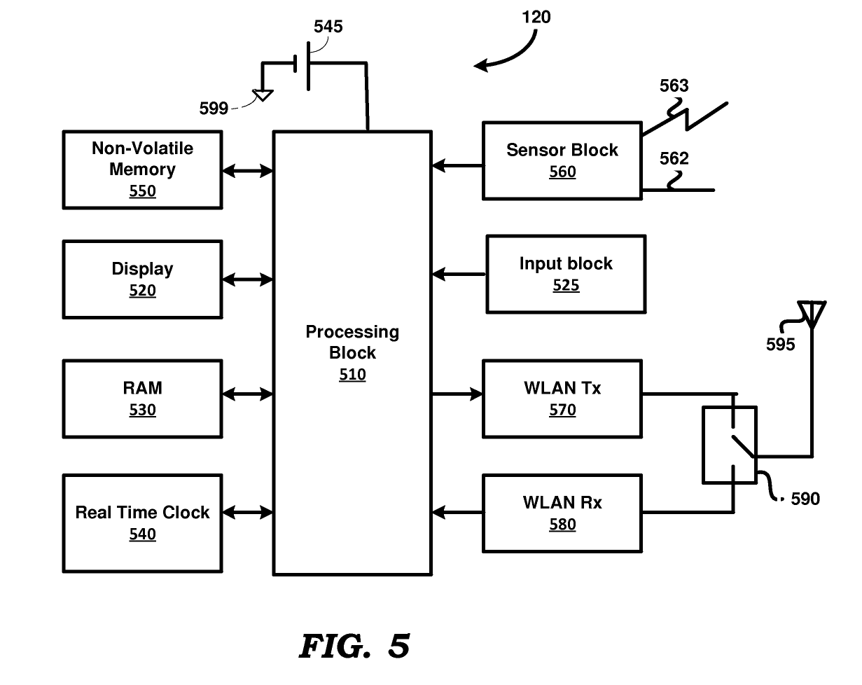

In step 220, STA 120 places its receiver in power savings mode during the inactive time durations. As used herein, the term ‘receiver’ refers to those hardware portions of STA 120 (excluding antenna 595 of FIG. 5, described below) that are used to receive a WLAN signal and demodulate the WLAN signal to extract data/control information in the WLAN signal. Depending on the specific implementation, the receiver may include circuitry to perform down-conversion of a WLAN RF signal, analog-to-digital conversion, sampling, baseband processing, etc, as is well known in the relevant arts. When set to power savings mode, power to some or all of the circuitry (hardware portions) of the receiver is turned OFF. In some implementations of STA 120, some of the receiver's operations (e.g., some or all baseband operations) may be performed by a processing block. In such implementations, the corresponding portion of the processing block may also be powered down (the term ‘receiver’ including such portions of the processing block), and/or the corresponding software instructions may not be executed. Control then passes to step 250.

In step 230, STA 120 receives data when the receiver is in active mode. Active mode refers to an operating mode, in which the RF as well as baseband portions of the receiver are powered ON (with clock gating to baseband removed if earlier applied), and thus enabled to receive and process WLAN signals, and extract data/information from the WLAN signals. STA 120 operates its receiver in active mode in time durations other than the inactive time durations (noted in step 210). Control then passes to step 299, in which the flowchart ends.

In an embodiment, the inactive time durations are configured in STA 120 by a user/administrator via corresponding inputs. Such input may be provided on a daily basis. Alternatively, the input may be provided only once in a longer time period (example, a month), and the inactive time durations may be the same for each day in the time period. Smaller or larger time durations than a day may also be used as the basis for specifying inactive time durations.

In another embodiment, instead of a user providing the inactive time durations, STA 120 downloads the inactive time durations from an external system, such as from server 140 (FIG. 1). The information may have been entered in server 140 by an administrator or alternatively determined by server 140 based on various data transfer patterns to/from the corresponding STA. In other words, the absence of any data transfer in a specified duration may the basis for concluding that the corresponding duration in future should also be expected to be an inactive time duration.

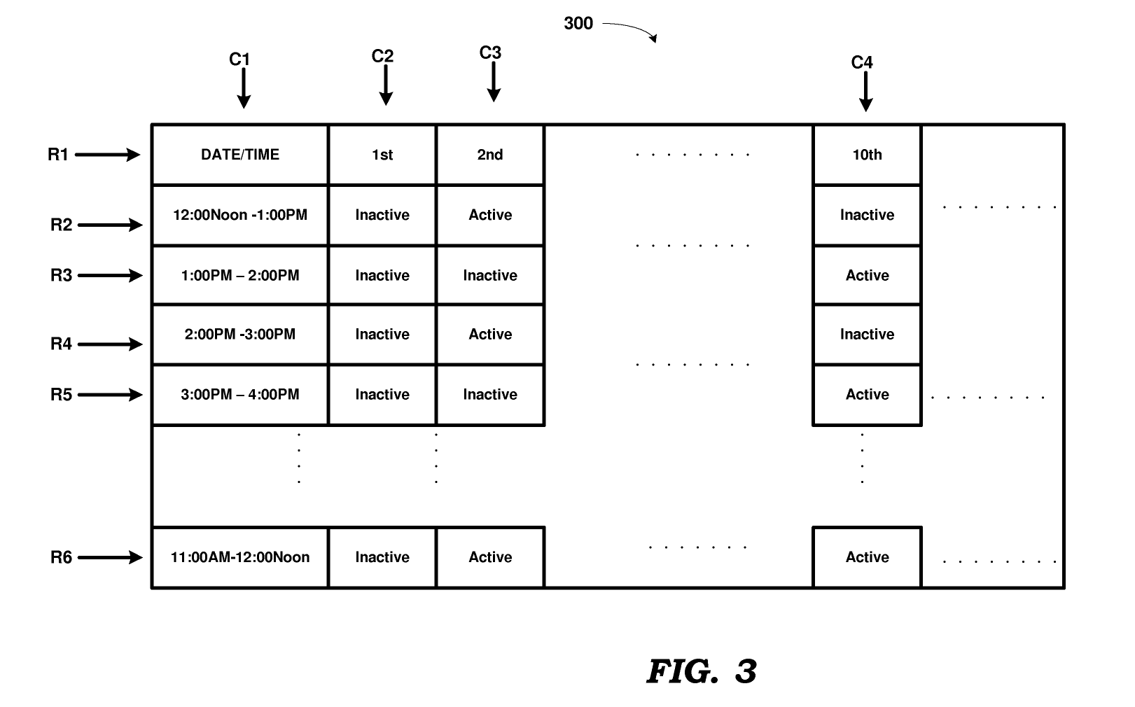

STA 120 may create a schedule representing inactive time durations and active time durations (in which STA 120 is to maintain the receiver in active mode), and store the schedule in local memory. FIG. 3 is diagram illustrating an example schedule 300 that may be created by STA 120. Column C1 of schedule 300 lists the time of day. Row R1 lists the dates. For conciseness, schedule 300 is shown containing entries only for columns C1-C4 and rows R1-R6. Columns C2-C4 represent the expected state for the corresponding day of the month.

Row R2 indicates the state (power savings or active) that STA 120 is to place its receiver in for the time interval 12:00 (noon) to 1:00 PM. Thus, as indicated by R2, STA 120 is to place its receiver in power savings mode (inactive) in that time interval for day 1, and day 10, and in active mode in that interval on day 2.

Row R3 indicates the state (power savings or active) that STA 120 is to place its receiver in for the time interval 1:00 PM to 2:00 PM. Thus, as indicated by R2, STA 120 is to place its receiver in power savings mode (inactive) in that time interval for day 1 and day 2, and in active (power-ON) mode on day 10. Row R4 indicates the state (power savings or active) that STA 120 is to place its receiver in for the time interval 2:00 Pm to 3:00 PM. Thus, as indicated by R4, STA 120 is to place its receiver in power savings mode (inactive) in that time interval for day 1 and day 10, and in active (power-ON) mode on day 2.

Row R5 indicates the state (power savings or active) that STA 120 is to place its receiver in for the time interval 3:00 PM to 4:00 PM. Thus, as indicated by R5, STA 120 is to place its receiver in power savings mode (inactive) in that time interval for day 1 and day 2, and in active (power-ON) mode on day 10. Row R6 indicates the state (power savings or active) that STA 120 is to place its receiver in for the time interval 11:00 AM to 12:00 noon. Thus, as indicated by R6, STA 120 is to place its receiver in power savings mode (inactive) in that time interval for day 1, and in active (power-ON) mode on day 2 and day 10.

In an embodiment of the present disclosure, whether or not STA 120 is to place its receiver in power savings mode is determined based on a priori knowledge of when data might be received, via AP 110, from an external device, such as STA 130 or a device/cloud in internet 150. For example, STA 120 may be designed to collect sensor data representing parameters temperature, pressure etc. A master control station (which could be server 140 itself) connected to internet 150 may issue a command to STA 120 at predetermined time instance to cause STA 120 to forward the collected sensor data. The predetermined time instance may be designed to occur in a time window such as between 12:00 noon to 1:00 PM on day 2, as indicated by row R2 and column C3.

As another example, server 140 may be designed to transmit firmware upgrades to be installed in STA 120 at pre-determined time intervals, such as for example, on day 2 and 10 in the interval 11:00 AM to 12:00 noon.

Operations of the corresponding devices according to the examples provided above are further illustrated below with respect to a timing diagram. However, the implementation details of a wireless station in an embodiment of the present disclosure are provided next.

### 4. Example Implementation

FIG. 5 is a block diagram showing the implementation details of a wireless station in an embodiment of the present disclosure. STA 120 is shown containing processing block 510, display 520, random access memory (RAM) 530, real-time clock (RTC) 540, battery 545, non-volatile memory 550, sensor block 560, WLAN transmitter (Tx) 570, WLAN receiver (Rx) 580, switch 590, and antenna 595. The whole of STA 120 may be implemented as a system-on-chip (SoC), except for battery 545 and antenna 595. Alternatively, the blocks of FIG. 5 may be implemented on separate integrated circuits (IC). Terminal 599 represents a ground terminal.

Battery 545 provides power for operation of STA 120, and may be connected to the various blocks shown in FIG. 5, although not shown as such. Although not shown in FIG. 5, STA 120 contains corresponding circuitry (such as power switches, for example) for selectively powering-ON and powering-OFF WLAN Rx 580, and (optionally) WLAN Tx 570 also. RTC 540 operates as a clock, and provides the ‘current’ time to processing block 510. STA 120 may communicate with a central server (in internet 150) that maintains accurate time, to correct/update the time maintained locally in RTC 540.

Antenna 595 (which corresponds to antenna 125 of FIG. 1) operates to receive from, and transmit to, a wireless medium, corresponding wireless signals according to IEEE 802.11 (WLAN) standards. Switch 590 may be controlled by processing block 510 (connection not shown) to connect antenna 595 to one of blocks 570 and 580 as desired, depending on whether transmission or reception of WLAN (IEEE 802.11) signals is required. Switch 590, antenna 595 and the corresponding connections of FIG. 5 are shown merely by way of illustration. Instead of a single antenna 595, separate antennas, one for transmission and another for reception of WLAN signals, can also be used. Various other techniques, well known in the relevant arts, can also be used instead.

Sensor block 560 may contain one or more sensors, as well as corresponding signal conditioning circuitry, and provides, to processing block 510, measurements/values of physical quantities such as temperature, pressure, etc., sensed via wired path 562 or wireless path 563. While sensor block 560 represents a source of data transmitted using wireless station 120, it should be appreciated that any user application executing in wireless station 120 can also be source of such data.

Input block 525 enables a user to provide inputs to STA 120, and may correspond to a keypad. The entries of schedule 300 of FIG. 3 may be provided to STA 120 via input block 525. Display 520 provides visual display to a user of various parameters (such as, for example, temperature/pressure values collected by sensor block 560). Display 520 (in conjunction with input block 525) may be used to display schedule 300 and edit its entries.

WLAN Tx 570 receives data to be transmitted according to WLAN standards from processing block 510, generates a modulated radio frequency (RF) signal according to IEEE 802.11 standards, and transmits the RF signal via switch 590 and antenna 595. WLAN Tx 570 may contain RF and baseband circuitry for generating and transmitting WLAN signals, as well as for medium access operations. Alternatively, WLAN Tx 570 may contain only the RF circuitry, with processing block 510 performing the baseband and medium access operations (in conjunction with the RF circuitry).

WLAN Rx 580 represents a receiver that receives an RF signal (according to IEEE 802.11/WLAN standards) bearing data and/or control information via switch 590, and antenna 595, demodulates the RF signal, and provides the extracted data or control information to processing block 510. WLAN Rx 580 may be implemented according to one of several well known approaches. Thus, for example, WLAN Rx 580 may contain RF as well as baseband processing circuitry for processing a WLAN signal. Alternatively, WLAN Rx 580 may contain only the RF circuitry, with processing block 510 performing the baseband operations in conjunction with the RF circuitry. WLAN Rx 580 may selectively be powered OFF and powered ON by controlling (by processing block 510, for example) corresponding circuitry, such as power switches (not shown), connecting WLAN Rx 580 to battery 545. Further, when WLAN Rx 580 includes baseband processing circuitry, such circuitry may also be selectively powered OFF and powered ON. Alternatively, the master clock provided for operation of such baseband circuitry may be capable of being gated OFF and gated ON by corresponding circuitry.

Non-volatile memory 550 is a non-transitory machine readable medium, and stores instructions, which when executed by processing block 510, causes STA 120 to operate as described above. In particular, the instructions enable STA 120 to operate as described with respect to the flowchart of FIG. 2, when implemented correspondingly. RAM 530 is a volatile random access memory, and may be used for storing instructions and data. Data specifying the inactive time durations (of flowchart of FIG. 2) may be stored in non-volatile memory 550 upon an administrator configuring the same.

Processing block 510 (or processor in general) may contain multiple processing units internally, with each processing unit potentially being designed for a specific task. Alternatively, processing block 510 may contain only a single general-purpose processing unit. Processing block 510 may execute instructions stored in non-volatile memory 550 or RAM 530 to enable device 120 to operate according to several aspects of the present disclosure, described above in detail.

Processing block 510 receives data (either via input block 525 or from an external device via WLAN Rx 580) specifying the inactive time durations corresponding to the receiver of STA 120, and stores the data in non-volatile memory 550. Processing block 510 examines the data in non-volatile memory 550 and issue corresponding control signals to selectively place the receiver of STA 120 in power savings mode or active mode in the corresponding time intervals (as specified by the examined data).

Processing block 510 may also issue control signals to selectively power-ON/power-OFF WLAN Tx 570 also. In some implementations of STA 120, processing block 510 may perform some operations (e.g., some or all baseband operations) related to receipt and demodulation of WLAN signals, as well as other operations such as decryption, error corrections, etc. In such implementations, the corresponding portion(s) of processing block 510 may be powered down, and/or the corresponding software instructions may not be executed in the power savings mode. In such implementations, the term ‘receiver’ as used herein refers to the combination WLAN Rx 580 and the corresponding portion(s) of processing block 510. When the receiver is in power savings mode, discharge of battery 545 may be reduced, thereby reducing power consumption.

RAM 530 and non-volatile memory 550 (which may be implemented in the form of read-only memory/ROM/Flash) constitute computer program products or machine (or computer) readable medium, which are means for providing instructions to processing block 510. Thus, such medium can be in the form of removable (floppy, CDs, tape, etc.) or non-removable (hard drive, etc.) medium. Processing block 510 may retrieve the instructions, and execute the instructions to provide several features of the present disclosure.

The description is continued with respect to a timing diagram illustrating the manner in which power is reduced in the receiver of STA 120, in an embodiment.

### 5. Timing Diagram

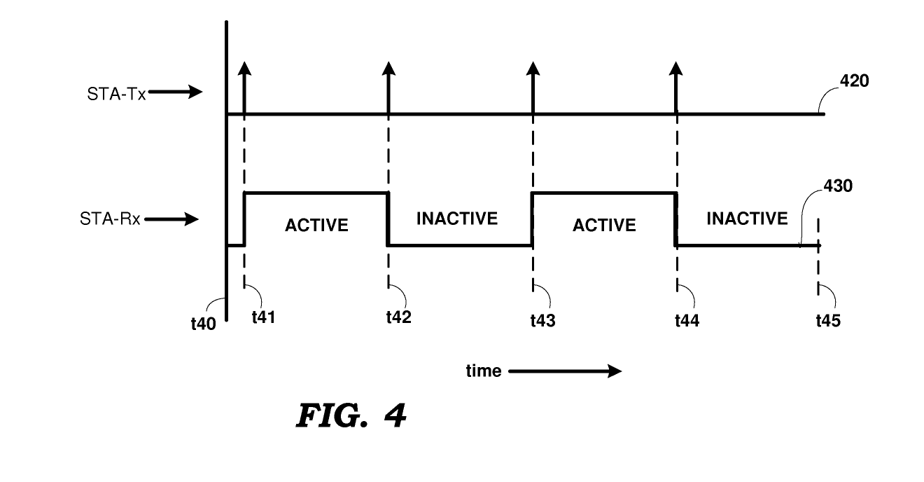

FIG. 4 is a timing diagram used to illustrate the manner in which power consumption in STA 120 is reduced, in an embodiment of the present disclosure. The waveforms of FIG. 4 may not be to scale. The diagram of FIG. 4 shows the operation in active and inactive durations corresponding to day 2 (Column C3).

Waveform 420 (STA-Tx) represents transmissions of WLAN signals from WLAN Tx 570. Waveform 430 represents the operational state (active mode/active durations and power savings/inactive durations) of the receiver of STA 120. Transmissions and reception from AP 110 are assumed to occur at the corresponding instances/intervals, but not shown in the interest of clarity. Further, It is assumed in the following description that STA 120 has associated and authenticated with AP 110 sometime prior to time instance t40. Also, it is assumed that STA 120 has synchronized its local clock (maintained in RTC 540) with a master clock maintained in AP 110. Further still, it is assumed that STA 120 has negotiated a listen interval in cooperation with AP 110, also prior to t40. The listen interval represents the maximum duration for which AP 110 can locally (within AP 110) buffer unicast data destined for STA 120. However, such listen intervals may be ignored by STA 120, since the active and inactive time durations of receiver of STA 120 are based on predetermined schedules as noted above.

At time instance t41, WLAN Tx 570 (under control of processing block 510) transmits a NULL frame to AP 110, with the Power Management (PM) bit in the NULL frame indicating that STA is to transition to the active mode. AP 110 stops buffering any data destined for STA 120. For the interval t41-t42, which is assumed to correspond to interval 12:00 noon to 1:00 PM of FIG. 3, the receiver of STA 120 is maintained in the active mode (power ON state), and STA 120 may receive data from AP 110. STA 120 may process the received data appropriately.

At t42, WLAN Tx 570 (under control of processing block 510) transmits a NULL frame to AP 110, with the Power Management (PM) bit in the NULL frame indicating that STA is to transition to the power savings mode. For the interval t42-t43, which is assumed to correspond to interval 1:00 PM to 2:00 PM of FIG. 3, the receiver of STA 120 is maintained in the power savings mode.

At t43, WLAN Tx 570 (under control of processing block 510) transmits a NULL frame to AP 110, with the Power Management (PM) bit in the NULL frame indicating that STA is to transition to the active mode. AP 110 stops buffering any data destined for STA 120. For the interval t43444, which is assumed to correspond to interval 2:00 PM to 3:00 PM of FIG. 3, the receiver of STA 120 is maintained in the active mode (power ON state), and STA 120 may receive data from AP 110. STA 120 may process the received data appropriately.

At t44, WLAN Tx 570 (under control of processing block 510) transmits a NULL frame to AP 110, with the Power Management (PM) bit in the NULL frame indicating that STA is to transition to the power savings mode. For the interval t44-t45, which is assumed to correspond to interval 3:00 PM to 4:00 PM of FIG. 3, the receiver of STA 120 is maintained in the power savings mode.

### 6. Conclusion

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of operating a wireless station of a wireless network, said method being performed in said wireless station, said method comprising:
examining data indicating inactive time durations during a day;
placing a receiver of said wireless station in power savings mode during said inactive time durations in corresponding days, wherein said receiver is used to receive data from said wireless network in active mode and is incapable of receiving data in said power savings mode; and
receiving data when operating in said active mode.

2. The method of claim 1, wherein said data indicating inactive time durations is received in the form of a sequence of intervals in each day, wherein each of said sequence of intervals is indicated to be either as one of said inactive time durations or a corresponding active time duration.

3. The method of claim 2, wherein said inactive time durations are configured by an administrator, wherein said data indicating said inactive time durations is stored in a non-volatile memory of said wireless device in response to the configuration, wherein said examining examines said data stored in said non-volatile memory.

4. The method of claim 2, wherein said inactive time durations are downloaded from an external server, and wherein said examined data represents the inactive durations downloaded from said server.

5. The method of claim 4, wherein said external server determines said inactive time durations by examining data patterns to and from said wireless station.

6. The method of claim 2, wherein said wireless network operates in accordance with IEEE 802.11 protocol.

7. The method of claim 6, wherein said wireless station transmits a respective NULL frame corresponding to each of said inactive time durations to an access point (AP) of said wireless network, with a power management bit of said NULL frame indicating that said receiver is to be placed in said power savings mode in each of said inactive time durations,
wherein, in response to receiving the respective NULL frame, said AP commences buffering data units destined for said wireless station.

8. A wireless station of a wireless network, said wireless station comprising:
an input block;
a receiver;
a non-volatile memory; and
a processor operable to perform the actions of:
examining data indicating inactive time durations during a day;
placing said receiver in power savings mode during said inactive time durations in corresponding days, wherein said receiver is used to receive data from said wireless network in active mode and is incapable of receiving data in said power savings mode; and
receiving data when operating in said active mode.

9. The wireless station of claim 8, wherein said processor receives said data indicating inactive time durations in the form of a sequence of intervals in each day, wherein each of said sequence of intervals is indicated to be either as one of said inactive time durations or a corresponding active time duration.

10. The wireless station of claim 9, wherein said inactive time durations are configured by an administrator using said input block, wherein said processor stores said data indicating said inactive time durations in said non-volatile memory in response to the configuration, wherein said processor examines said data stored in said non-volatile memory.

11. The wireless station of claim 9, wherein said processor downloads said inactive time from an external server, wherein said examined data represents the inactive durations downloaded from said server.

12. The wireless station of claim 11, wherein said external server determines said inactive time durations by examining data patterns to and from said wireless station.

13. The wireless station of claim 9, wherein said wireless network operates in accordance with IEEE 802.11 protocol.

14. The wireless station of claim 13, wherein said wireless station transmits a respective NULL frame corresponding to each of said inactive time durations to an access point (AP) of said wireless network, with a power management bit of said NULL frame indicating that said receiver is to be placed in said power savings mode in each of said inactive time durations,
wherein, in response to receiving the respective NULL frame, said AP commences buffering data units destined for said wireless station.

15. A non-transitory machine readable medium storing one or more sequences of instructions for operating a wireless station of a wireless network, wherein execution of said one or more instructions by one or more processors contained in said wireless station enables said wireless station to perform the actions of:
examining data indicating inactive time durations during a day;
placing a receiver of said wireless station in power savings mode during said inactive time durations in corresponding days, wherein said receiver is used to receive data from said wireless network in active mode and is incapable of receiving data in said power savings mode; and
receiving data when operating in said active mode.

16. The non-transitory machine readable medium of claim 15, wherein said data indicating inactive time durations is received in the form of a sequence of intervals in each day, wherein each of said sequence of intervals is indicated to be either as one of said inactive time durations or a corresponding active time duration.

17. The non-transitory machine readable medium of claim 16, wherein said inactive time durations are configured by an administrator, wherein said data indicating said inactive time durations are stored in a non-volatile memory of said wireless device in response to the configuration, wherein said examining examines said data stored in said non-volatile memory.

18. The non-transitory machine readable medium of claim 16, wherein said inactive time durations are downloaded from an external server, and wherein said examined data represents the inactive durations downloaded from said server.

19. The non-transitory machine readable medium of claim 18, wherein said external server determines said inactive time durations by examining data patterns to and from said wireless station.

20. The non-transitory machine readable medium of claim 16, wherein said wireless network operates in accordance with IEEE 802.11 protocol,
wherein said wireless station transmits a respective NULL frame corresponding to each of said inactive time durations to an access point (AP) of said wireless network, with a power management bit of said NULL frame indicating that said receiver is to be placed in said power savings mode in each of said inactive time durations,
wherein, in response to receiving the respective NULL frame, said AP commences buffering data units destined for said wireless station.
